(19) United States
(12) Patent Application Publication
(10) Pub. No.: US 2006/0235744 A1
(43) Pub. Date: Oct. 19, 2006

(54) WEIGHT LOSS METHOD

(76) Inventor: Padraic McCahill, North Easton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/277,574

(22) Filed: Mar. 27, 2006

Related U.S. Application Data
(60) Provisional application No. 60/668,477, filed on Apr. 5, 2005.

(51) Int. Cl. G06Q 30/00

(52) U.S. Cl. 705/14

(57) ABSTRACT

A method for weight loss includes collecting a fee from each participant in a group of participants who desire to lose an amount of weight within a determined amount of time. Participants are weighed at the beginning of the determined amount of time. The participants are allowed to engage in activities that would allow weight loss. The participants are weighed after a determined amount of time, and the change in weight of the individual participants is calculated. A determination of which participants have lost the desired amount of weight within the determined amount of time is made. A portion of the collected fees is distributed to the participants who have lost the desired weight. The distributed portion of the collected fees can include travel vouchers, gift certificates or other reward structures.

### RELATED APPLICATION

This application claims the benefit of U.S. Provisional Application No. 60/668,477, filed on Apr. 5, 2005. The entire teachings of the above application are incorporated herein by reference.

### BACKGROUND

For a variety of reasons, primarily health, many people in the United States are concerned with achieving and maintaining a particular body weight or range of body weights. Most of these people are concerned about being overweight, and want to reduce.

Obesity is becoming the number one health problem facing the United States. We live in an era of relative overabundance of food. Humans have evolved to store fat in times of plenty. The problem is that many people have time of plenty twelve months a year. Over consumption is easy and relatively cheaper than in any time of civilization. Yet modern life is surprisingly hard so often people reward themselves with food and beverage just for getting through the day or a stressful situation. Procrastination is an under-recognized problem with weight loss and a major cause of failure to adhere to a diet regimen. Dieters wish to lose weight, but just not today.

### SUMMARY

A method for weight loss includes collecting a fee from each participant in a group of participants who desire to lose an amount of weight within a determined amount of time. Participants are weighed at the beginning of the determined amount of time. The participants are allowed to engage in activities that would allow weight loss. The participants are weighed after the determined amount of time, and the change in weight of the individual participants is calculated. A determination of which participants have lost the desired amount of weight within the determined amount of time is made. A portion of the collected fees is distributed to the participants who lost the desired weight. In one embodiment, the distributed portion of the collected fees may include travel vouchers, gift certificates or other reward structures.

### BRIEF DESCRIPTION OF THE DRAWINGS

The foregoing and other features and advantages of the invention will be apparent from the following more particular description of embodiments of the invention, as illustrated in the accompanying drawings.

FIG. 1 is a flow diagram illustrating a weight loss method in accordance with principles of the present invention.

FIG. 2 is a flow diagram of an alternate embodiment of a weight loss method in accordance with principles of the present invention.

### DETAILED DESCRIPTION

The weight loss method is a new approach to weight loss, and can be practiced in the context of a travel and weight loss club. Club participants reward themselves with travel to motivate weight loss. Although travel is exemplified throughout this application, other type of rewards are foreseen, such as gift certificates for shopping, which would motivate participants to lose weight.

Essentially, a pact is made among a group of participants who agree to a deadline for a specified amount of weight loss. Money in the form of collected fees, which may be used in whole or in part directly for travel or to finance the purchase of travel vouchers, gift certificates or other rewards, is pooled at the weigh-in date. After a specified length of time, participants are weighed again. If all the participants meet the weight loss goal, all the participants can travel. If a participant fails to meet the weight loss goal, he forfeits part of his travel money to his group. If after an additional two months the weight loss goal is still not met, the remainder of the money is disbursed to the participants of the group. All money to be used for travel is arranged by the weight loss center. After a participant has used this technique to reach a desired weight, he can enter a similar arrangement for weight maintenance.

A weight loss center may function as a referee for the participants. It may keep the pooled money in escrow. The center may provide the service of the weigh in and weigh out. It may act as a travel agent for the participants after they have met their weight loss goals, and may provide weight loss advice to the participants. In addition, the weight loss center may provide interim goals for clients and encourage interim weigh ins. Though not required to practice the present invention, as with any program relating to weight loss, participants may be advised to sign a waiver stating they understand the program and its risks and to pledge to lose weight without the use of diuretics, laxatives or other drugs and without the use of a steam room.

At some point after the initial weigh in, e.g., one month, a participant may buy out of the pact. This participant may forfeit the initial fee to the weight loss center and may forfeit an additional amount of money, such as $50, to each of the other participants of his group.

If a participant becomes pregnant at any time during the weight-loss period, she may buy out of the pact.

The participants may know the names of the other participants in the group. Participants may have the option of revealing or not revealing their actual weights to their group.

It is preferable that the target weight be no lower than the ideal weight for the participant's height.

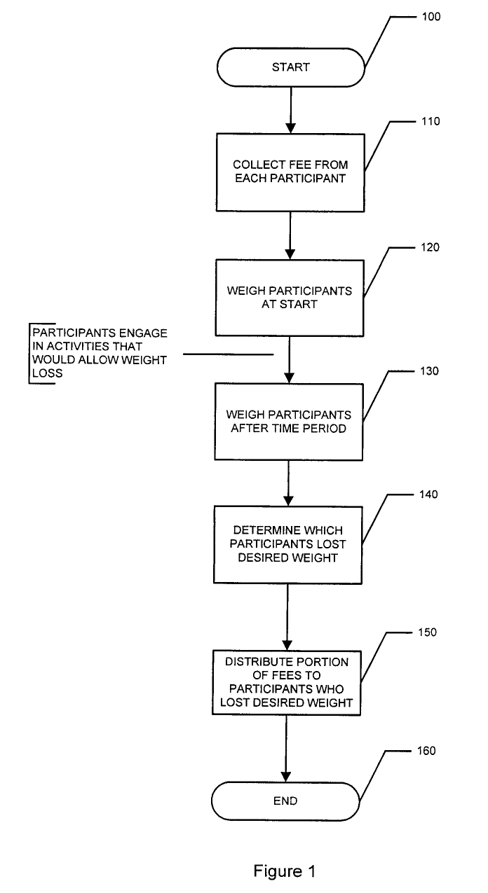

FIG. 1 illustrates an embodiment of the method of the present invention. At the start 100, fees are collected from the participants in step 110. For example, the participants mayjoin the club for an initiation fee. In one embodiment, the “initiation fee” is $50. The participants sign waivers and pledges, and may write a check or use a credit card to deposit, such as $1,000, for travel to the club.

Club participants may choose a certain amount of weight loss in a fixed period of time. For example, one embodiment can include 15 pounds weight loss in four months or twenty pounds weight loss in six months. The participants are weighed at the start of the determined time period at step 120. The participant weighs in, e.g., with empty pockets and no shoes or jacket. Height may also be measured. The participant may be grouped, e.g., with three or more participants with the same weight loss goal. Groups can, if desired, be made from people who know each other. Otherwise, groups may be assembled by same gender and by approximate range from ideal weight. It has been found to be easier, e.g., to lose weight if one is 100 pounds over weight rather than 20 pounds.

Having weighed in for the start of the program at step 120, participants now attempt to lose weight. Participants can opt to join or not join any other weight loss club or gym. The weight loss program can work in partnership with a local gym for limited memberships. Participants are encouraged to weigh themselves at home at least weekly. Messages can be sent by mail and can be weekly with tips, encouragement and interim goals. Participants may also be encouraged to stop by and weigh in at the weight loss center on its official scale, especially prior to a “point of no return” time, e.g., one month into the program, and again as the deadline nears.

After a period of time, the participants are weighed again at step 130. In a four month program, after three months, but before the four months is reached, participants may weigh in. The target weight must be made prior to the four month deadline. For those who chose the 20 pounds in six months option, the weigh in may be after five months, but before six months.

A determination is made as to which participants lost the desired weight at step 140. A participant who does not make weight may cede $500 or another agreed upon amount to the other participants in the group who did make weight. Alternatively, a distribution of collected fees (which may include travel vouchers, gift certificates or other rewards) is simply made to those who did make weight at step 150.

In the event that nobody in the group reaches the target weight, then all money may be returned to the participants minus a processing fee, such as about $50.

After participants have reached the target weight, they then may schedule their travel, using their travel money as well as any additional money they would like to spend. They may also schedule their travel companions through the weight loss center. After the weight loss center has been in business for some time, it can offer a weight maintenance group. Participants who have reached their desired weight may form groups to maintain a desired weight for a period of one year.

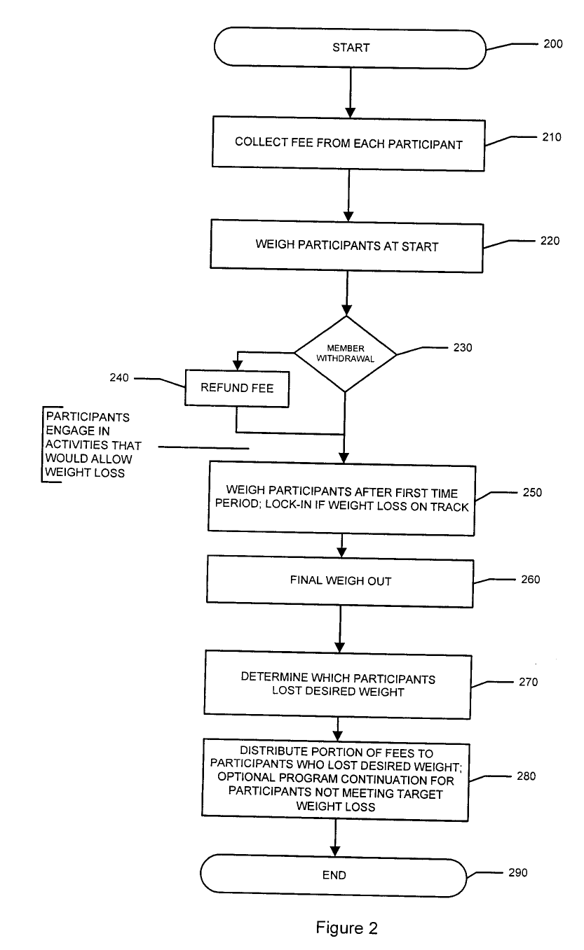

An alternate embodiment of a weight loss program in accordance with the principles of the present invention is illustrated in FIG. 2.

At the start 200, a joining fee and travel pool fees are collected from the participants in step 210. The participants are weighed at the start of a determined time period at step 220. Having weighed in for the start of the program at step 220, participants now attempt to lose weight. After one month or other period of time, members can withdraw at 230 by paying a small fee and receive a refund of the bulk of their travel fund contribution at 240. After a period of time, the participants are weighed again at step 250. At this stage, members may lock-in a portion of their travel pool share if their weight loss is on track. The target weight must be made prior to the four month deadline at the final weigh out at 260.

A determination is made as to which participants lost the desired weight at step 270. A participant who does not make weight may cede $500 or another agreed upon amount to the other participants in the group who did make weight. Alternatively, a distribution of collected fees (which may include travel vouchers, gift certificates or other rewards) is simply made to those who did make weight at step 280. A participant, who does not make weight, then may have additional time to make weight and claim one-half share of the travel money. If the participant again fails to meet the target weight, the remainder of the participant's travel money may go to the group participants who did make weight.

In the event that nobody in the group reaches the target weight, then all money may be returned to the participants minus a processing fee, such as about $50.

After participants have reached the target weight, they then may schedule their travel, using their travel money as well as any additional money they would like to spend. They may also schedule their travel companions through the weight loss center. After the weight loss center has been in business for some time, it can offer a weight maintenance group. Participants who have reached their desired weight may form groups to maintain a desired weight for a period of one year.

The weight loss method provides a mechanism for making over consumption expensive. It introduces a non-caloric reward for meeting a goal. It harnesses one's competitive spirit. A third party may do the weighing so that there is minimization of cheating or backsliding on the goal. The method introduces risk. One should be sufficiently motivated to lose weight just for the health benefits. But clearly some people are not sufficiently motivated. The weight loss method combats a primary reason that people have trouble losing weight—procrastination. When a concrete deadline is set, people can meet the deadline. Jockeys, boxers and wrestlers have had to meet target weights. The U.S. Army now requires that soldiers weigh in twice per year. Target weights are set and being overweight can prevent promotion. This described method is not gambling or a lottery. There is no wager on a game of chance. Instead, the method is an agreement among individuals to spend money on travel or another type of reward but only if a condition can be met.

It should be understood that any of the data collecting or processing may be implemented in hardware, firmware, or software. If implemented in software, instructions may be stored on computer-readable media, such as magnetic disk, optical disk, read only memory (ROM), random access memory (RAM), loaded on a server and transmitted across a computer network, or stored on any other form of computer readable medium. A processor loads the software instructions from the computer-readable medium and executes the instructions to perform the processes described herein.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for weight loss comprising:
collecting a fee from each of a plurality of participants who desire to lose an amount of weight within a determined amount of time;
weighing participants at the beginning of the determined amount of time;
allowing participants to engage in activities that would allow weight loss;
weighing participants after the determined amount of time and calculating the change in weight of each individual participant;
determining which participants have lost the desired amount of weight within the determined amount of time; and
distributing a portion of the collected fees to the participants determined to have lost the desired weight.

2. The method of claim 1 wherein the distributed portion of the collected fees includes travel vouchers.

3. The method of claim 1 wherein the distributed portion of the collected fees includes gift certificates.

4. The method of claim 1 wherein collecting fees and weight information is conducted by a non-participant.

5. The method of claim 4 wherein the non-participant is a weight loss center.

6. The method of claim 1 wherein a participant who has lost the desired weight and has maintained the desired weight loss for an additional period of time receives an additional portion of the collected fees.
